(19) United States
(12) Patent Application Publication
(10) Pub. No.: US 2014/0164594 A1
(43) Pub. Date: Jun. 12, 2014

(54) INTELLIGENT PLACEMENT OF VIRTUAL SERVERS WITHIN A VIRTUALIZED COMPUTING ENVIRONMENT

(71) Applicant: INTERNATIONAL BUSINESS MACHINES CORPORATION, Armonk, NY (US)

(72) Inventors: Susan F. Crowell, Rochester, MN (US); Jason A. Nikolai, Rochester, MN (US); Andrew T. Thorstensen, Rochester, MN (US)

(73) Assignee: INTERNATIONAL BUSINESS MACHINES CORPORATION, Armonk, NY (US)

(21) Appl. No.: 13/710,615

(22) Filed: Dec. 11, 2012

(51) Int. Cl. H04L 12/26; G06F 9/455

(52) U.S. Cl. CPC H04L 43/08; G06F 9/455
USPC 709/224

(57) ABSTRACT

A method for recommending placement of virtual servers within a virtualized environment. The method includes collecting information relating to a plurality of virtual servers and to a plurality of host computing systems, wherein one or more of the plurality of host computing systems hosts at least one of the plurality of virtual servers. The method includes measuring efficiency of at least one of the plurality of virtual servers on a current host computing system within the virtualized environment. The method includes determining the efficiency of the at least one virtual server will be improved with the at least one virtual server on a second host computing system and, in response to determining the efficiency will be improved, recommending placement of the at least one virtual server on the second host computing system.

### FIELD OF THE INVENTION

The present invention relates generally to the field of virtualized computing environments, and more particularly to intelligent placement of virtual servers within a virtualized computing environment.

### BACKGROUND OF THE INVENTION

Virtualization is a core component to data centers and allows a great deal of flexibility in the provisioning and placement of servers and their associated workloads in a data center. In system virtualization, multiple virtual computing systems are created within a single physical computing system. The physical system can be a stand-alone computer, or alternatively, a computing system utilizing clustered computers and components. Virtual systems are independent operating environments that use virtual resources made up of logical divisions of physical resources such as processors, memory, and input/output (I/O) adapters. System virtualization is implemented through some managing functionality, typically hypervisor technology. Hypervisors, also called virtual machine managers (VMMs), use a thin layer of code in software or firmware to achieve fine-grained, dynamic resource sharing. Hypervisors are the primary technology for system virtualization because they provide the greatest level of flexibility in how virtual resources are defined and managed.

Hypervisors provide the ability to divide physical computing system resources into isolated logical partitions. Logical partitioning is the ability to make a server run as if it were two or more independent servers. Each logical partition operates like an independent computing system running its own operating system (also referred to as a virtual system, virtual server, or virtual machine). Operating systems running in a virtualized computing environment are often referred to as “guest machines.” Hypervisors can allocate dedicated processors, I/O adapters, and memory to each logical partition and can also allocate shared processors to each logical partition. Unbeknownst to the logical partitions, the hypervisor may also create a shared processor pool from which the hypervisor allocates virtual processors to the logical partitions as needed. In other words, the hypervisor creates virtual processors from physical processors so that logical partitions can share the physical processors while running independent operating environments.

In addition to creating and managing the logical partitions, the hypervisor manages communication between the logical partitions via a virtual network. To facilitate communication, each logical partition may have a virtual adapter for communication between the logical partitions, via the virtual network. The type of the virtual adapter depends on the operating system and network protocol used by the logical partition. Examples of virtual adapters include virtual Ethernet adapters, virtual Fibre Channel adapters, virtual Small Computer Serial Interface (SCSI) adapters, and virtual serial adapters.

### SUMMARY

Embodiments of the present invention disclose a method, computer program product, and computer system for recommending placement of virtual servers within a virtualized computing environment. The method includes collecting information relating to a plurality of virtual servers and information relating to a plurality of host computing systems, wherein one or more of the plurality of host computing systems hosts at least one of the plurality of virtual servers. The method includes measuring efficiency of at least one of the plurality of virtual servers located on a current host computing system within the virtualized environment. The method includes determining, based on the collected information, whether the efficiency of the at least one virtual server will be improved with the at least one virtual server located on a second host computing system. The method further includes, in response to determining the efficiency will be improved, recommending placement of the at least one virtual server on the second host computing system.

### BRIEF DESCRIPTION OF THE SEVERAL VIEWS OF THE DRAWINGS

FIG. 1 is a functional block diagram illustrating a virtualized computing environment, in accordance with an embodiment of the present invention.

FIG. 2 illustrates a virtual computing system, in accordance with an embodiment of the present invention.

FIG. 3 is a flowchart depicting operational steps of a recommending program for recommending placement of virtual servers within a virtualized computing environment based on service and support data, in accordance with an embodiment of the present invention.

FIG. 4 depicts a block diagram of components of the client computing device shown in FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems and billing for use of the systems.

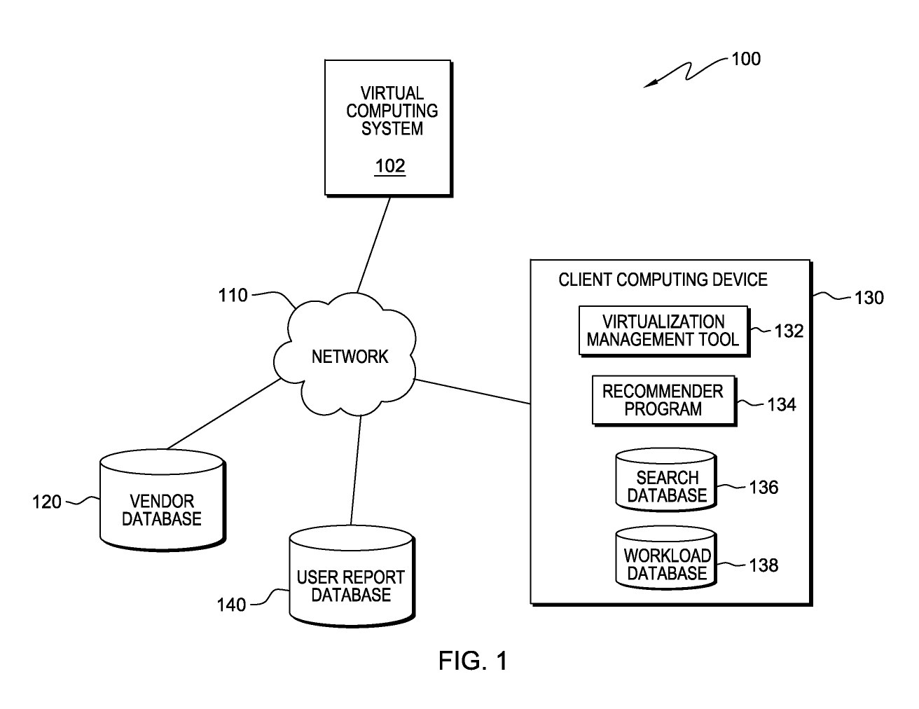

The present invention will now be described in detail with reference to the Figures. FIG. 1 is a functional block diagram illustrating a virtualized computing environment, generally designated 100, in accordance with an embodiment of the present invention.

Virtualized computing environment 100 includes a virtual computing system 102, a vendor database 120, a client computing device 130 and a user report database 140, all interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between virtual computing system 102, vendor database 120, client computing device 130, and user report database 140.

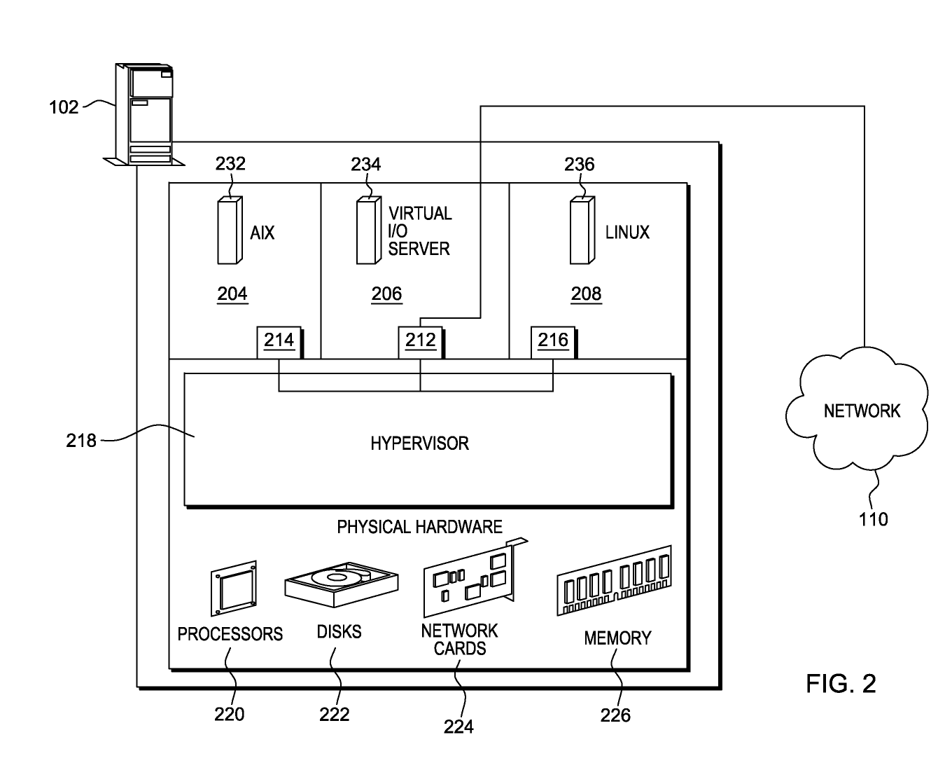

In one embodiment of the present invention, virtual computing system 102 represents a computing system utilizing clustered computers and components to act as a single pool of seamless resources when accessed through a network. This is a common implementation for data centers and for cloud computing applications. Virtual computing system 102 is described in further detail with reference to FIG. 2.

Vendor database 120 contains information provided by data sources and vendors, for example, IBM®, regarding relationships and known or suggested configurations between types of hardware and software. The information stored in vendor database 120 may contain, for example, service and support data, including software updates, security updates or warnings discovered by the vendors during testing and operations. While in FIG. 1, vendor database 120 is shown as being located on a storage device accessible to both virtual computing system 102 and client computing device 130 via network 110, one of skill in the art will appreciate that in other embodiments, vendor database 120 may be included on either virtual computing system 102 or client computing device 130.

User report database 140 contains information reported by users regarding discovered issues or recommendations for various combinations of workloads that either work well or do not work well. For example, in virtualized computing environment 100 there may be a virtual computing system that passes diagnostic tests, yet still sometimes experiences outages. User report database 140 may contain a report filed by a user recommending avoiding the specific virtual computing system for critical workloads. While in FIG. 1, user report database 140 is shown as being located on a storage device accessible to both virtual computing system 102 and client computing device 130 via network 110, one of skill in the art will appreciate that in other embodiments, user report database 140 may be located on either virtual computing system 102 or client computing device 130.

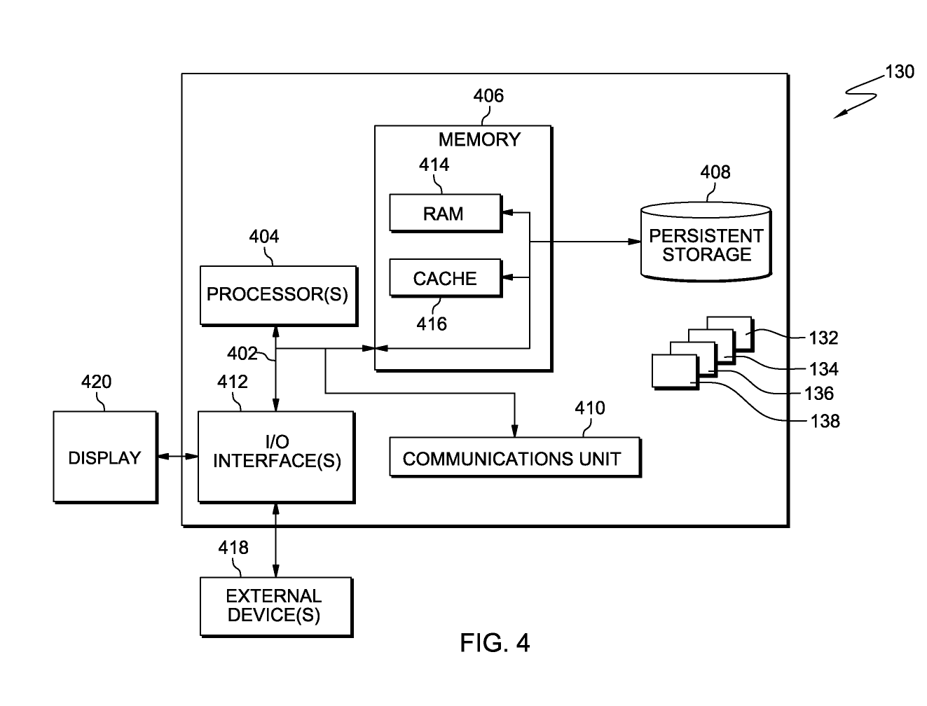

In various embodiments of the present invention, client computing device 130 can be a laptop computer, a notebook computer, a personal computer (PC), a desktop computer, a tablet computer, a handheld computing device or smart-phone, a thin client, or any other electronic device or computing system capable of executing machine-readable instructions and communicating through network 110. Client computing device 130 may include internal and external hardware components, as depicted and described in further detail with respect to FIG. 4. Client computing device 130 includes a virtualization management tool 132, a recommender program 134, a search database 136 and a workload database 138.

Virtualization management tool 132 requests, via network 110, and stores information about types of virtual servers in use, general workload information such as workload types or requirements, and information about the virtualized computing environment 100, such as types of hardware, operating systems and any attached devices.

Recommender program 134 uses the information collected by virtualization management tool 132, information, including updates, stored in vendor database 120, information and reports stored in user report database 140, user created commands found in search database 136 and workload priority groups stored in workload database 138 to prioritize a list of host virtual computing systems, such as virtual computing system 102, for relocation and placement of virtual servers within virtualized computing environment 100.

Search database 136 stores information such as user created commands, such as search requests, for searching vendor information available via network 110, for example, internet discussion forums. User created commands may include searches for key terms such as application names, serial numbers, or problem descriptions. Workload database 138 contains workload priority groups, which are created by a user. A user may group certain workloads into a “critical” group, which may include mission critical applications, and other workloads into a “low priority” group, which may include test workloads or development workloads. While in FIG. 1, search database 136 and workload database 138 are shown as located on client computing device 130, one of skill in the art will appreciate that both search database 136 and workload database 138 may be located on a storage device accessible to client computing device 130 via network 110.

FIG. 2 illustrates a virtual computing system, in accordance with an embodiment of the present invention. Virtual computing system 102, located within virtualized computing environment 100 (not shown), is divided into multiple logical partitions 204, 206, and 208. In the illustrated example, each of the respective logical partitions 204, 206, and 208 runs an independent operating environment, such as an operating system (OS). In an embodiment of the present invention, logical partition 204 runs an OS 232, which can be the AIX® operating system from International Business Machines (IBM) of Armonk, logical partition 206 runs an OS 234, which can be a Visual Internet Operating System (VIOS), and logical partition 208 runs an OS 236, which can be the Linux® operating system. Other operating environments and combinations of operating environments may be used. In various embodiments of the present invention, any number of partitions may be created and may exist in whole or in part on separate physical computers of a clustered computer system.

Communications from network 110 may be routed through Shared Ethernet adapter (SEA) 212 on logical partition 206 to virtual adapters 214 and 216 on respective logical partitions 204 and 208. Communications from virtual adapters 214 and 216 on respective logical partitions 204 and 208 may be routed through SEA 212 on VIOS partition 206 to network 110. In an alternative embodiment, physical network adapters may be allocated to logical partitions 204, 206, and 208.

Hypervisor 218 forms logical partitions 204, 206, and 208 from the physical resources of virtual computing system 102 through logical sharing of designated processors 220, storage disks 222, network cards 224, and/or memory 226 among logical partitions 204, 206, and 208. Hypervisor 218 performs operating system functions and manages communication between logical partitions 204, 206, and 208.

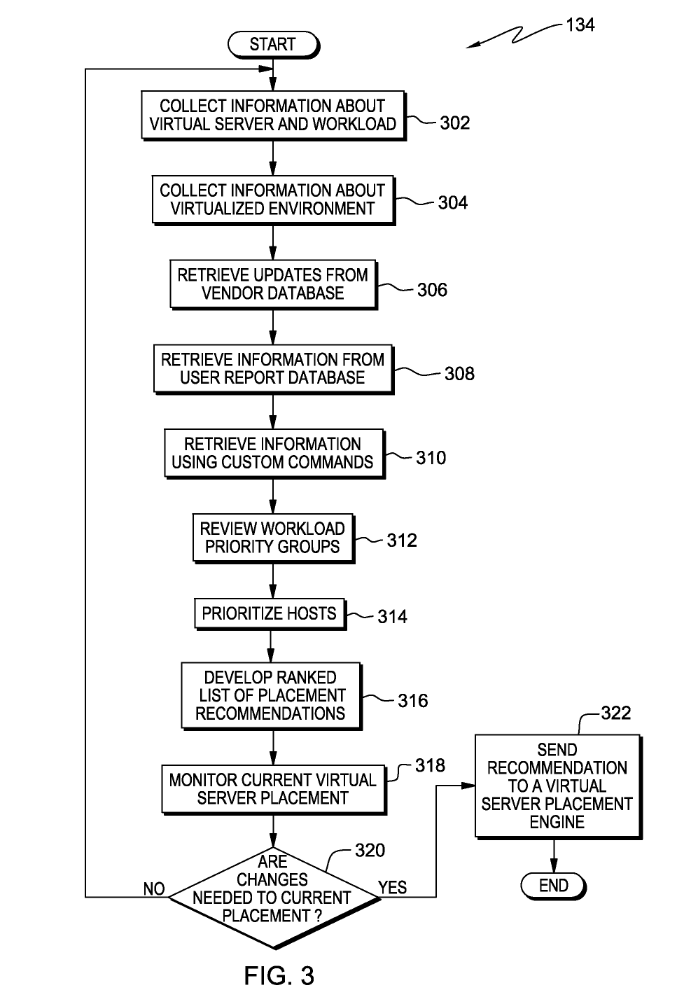

FIG. 3 is a flowchart depicting operational steps of the recommender program 134 for recommending placement of virtual servers within the virtualized computing environment 100 based on service and support data, in accordance with an embodiment of the present invention.

Recommender program 134 collects information about virtual servers and workloads within a virtualized environment, for example, virtualized computing environment 100, from virtualization management tool 132 (block 302). Collected information may include types of workloads (for example, CPU intensive, high volume, or I/O intensive), types of virtual servers and current locations of virtual servers. Recommender program 134 collects information about the virtualized environment from virtualization management tool 132 (block 304). Virtualized environment information may include types of hardware, memory and system board information for host virtual computing systems, operating systems and any attached devices included within virtualized computing environment 100.

Recommender program 134 retrieves updates from vendor database 120 (block 306). Vendor database 120 contains information from vendors and other data sources that may include, for example, security updates and warnings or software defects or release events. Recommender program 134 retrieves information from user report database 140 (block 308). Information stored in user report database 140 is provided by users and may include new issues or configurations that work, or do not work, for certain workloads. User report database 140 may be updated over time as issues and configurations are discovered.

Recommender program 134 retrieves information using custom commands (block 310). Custom commands are created by a user and stored in search database 136. Custom commands may include requests to search, via network 110, external sources such as internet websites, including specific vendor websites, web forums, customer support pages or social networking feeds, for key terms or phrases.

Recommender program 134 reviews workload priority groups (block 312). Workload priority groups are created by a user and can be stored in workload database 138. Workload priority groups may be based on type of workload, for example, development or test, or can be assigned as a tiered system, for example, a tier one workload has a higher importance than a tier four workload. Recommender program 134 may review workload priority groups to determine placement for critical groups, for example, production workloads, on more secure hosts, or placement for low priority groups, for example, test workloads, on busy or less secure hosts. For example, a host virtual computing system that experiences high volume data traffic during certain hours may not be optimal for a critical, time-sensitive, workload that must also run during those hours.

Recommender program 134 prioritizes available hosts based on the collected and retrieved information (block 314). Using the collected and retrieved information, for example, vendor recommendations or updates, known issues with firmware or driver levels and pairings, user reported issues, search request results, workload types and priority groups and hardware information, recommender program 134 determines which host virtual computing systems within virtualized computing environment 100, for example, virtual computing system 102, may be incompatible, optimal or average for a specific workload. Recommender program 134 uses a weighting algorithm which assigns cumulative values for host computing systems, for example, host computing systems that may be incompatible for the specified workload, host computing systems that may perform low for the specified workload and optimal host computing systems for the specified workload. For example, retrieved information may include details regarding a certain network card that is known to have issues under high volumes of data. Recommender program 134 may set a low value for a machine containing such a network card when determining available hosts for a high volume workload.

Recommender program 134, using the assigned cumulative values, generates a list of prioritized host computing systems for the specific workload type being relocated. Recommender program 134 takes into account workload priority and may, for example, give host computing system priority to a critical workload group. For example, if both a critical production workload and a test workload are optimal for a same host computing system, recommender program 134 would recommend the critical production workload for placement before the test workload on the same host computing system. Recommender program 134 develops a ranked list of placement recommendations for current virtual servers in virtualized environment 100 using the generated list of prioritized host computing systems and workload priority groups (block 316).

Recommender program 134 monitors current virtual server placements (block 318) and determines whether or not changes are needed to any current placement in order to optimize efficiency of the virtualized computing environment (decision block 320). Efficiency is the accomplishment of or ability to accomplish a job with a minimum expenditure of time and effort. Efficiency may be measured by the overall functional capability of the virtualized computing environment, and may include one or more of the following factors, such as time to complete workloads, success rate of workloads, ability of a virtual server to perform multiple workloads, and a count of any errors reported by the virtual server during processing of a workload. If changes are not needed (decision block 320, no branch), for example, workloads are being processed in the time and manner needed and current configurations are functioning without error, recommender program 134 returns to collect information about the virtual servers, workloads, and virtualized environment in order to develop placement recommendations. If changes are needed to the current virtual server placement (decision block 320, yes branch), recommender program 134 sends a recommendation, in the form of the developed ranked list, to a virtual server placement engine, such as those sold under the trademarks IBM® VMControl™ or VMware® vMotion™, which can relocate virtual servers with no impact to end users (block 322).

FIG. 4 depicts a block diagram of components of client computing device 130, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Client computing device 130 is representative of any electronic device capable of executing machine-readable program instructions. Client computing device 130 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. Computer-readable storage media can be any piece of hardware that is capable of storing information, such as, data, program code in functional form, and/or other suitable information on a temporary basis and/or permanent basis. Memory 406 may be, for example, one or more random access memories (RAM) 414, cache memory 416, or any other suitable volatile or non-volatile computer-readable storage media.

Virtualization management tool 132, recommender program 134, search database 136 and workload database 138 on client computing device 130 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including between virtual computing system 102 and client computing device 130. In these examples, communications unit 410 includes one or more network interface cards. Communications unit 410 may provide communications through the use of either or both physical and wireless communications links. Virtualization management tool 132, recommender program 134, search database 136 and workload database 138 on client computing device 130 may be downloaded to persistent storage 408 through communications unit 410.

I/O interface(s) 412 allows for input and output of data with other devices that may be connected to client computing device 130. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. In a preferred embodiment, I/O interfaces are also shared among logical partitions. Software and data used to practice embodiments of the present invention, e.g., virtualization management tool 132, recommender program 134, search database 136 and workload database 138, on client computing device 130 can be stored on such portable computer-readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for recommending placement of virtual servers within a virtualized computing environment, the method comprising the steps of:
collecting information relating to a plurality of virtual servers within a virtualized computing environment;
collecting information relating to a plurality of host computing systems within the virtualized computing environment, wherein one or more of the plurality of host computing systems hosts at least one of the plurality of virtual servers;
measuring efficiency of one of the plurality of virtual servers on a current host computing system within the virtualized computing environment;
determining, by one or more computer processors, based on the collected information relating to the plurality of virtual servers and the collected information relating to the plurality of host computing systems, whether the efficiency of the one virtual server will be improved with the one virtual server on a second host computing system; and
responsive to determining the efficiency of the one virtual server will be improved with the one virtual server on a second host computing system, recommending placement of the one virtual server on the second host computing system.

2. The method of claim 1, wherein the efficiency of the one of the plurality of the virtual servers is measured based on at least one of the following: time to complete a workload, resources required to complete a workload, success rate of a workload, errors reported during processing of a workload and ability to perform processing of multiple workloads.

3. The method of claim 1, wherein the step of recommending placement of the one virtual server includes sending the recommendation to a virtual server placement engine.

4. The method of claim 1, further comprising:
determining, based on the collected information relating to the plurality of virtual servers and the collected information relating to the plurality of host computing systems, whether a virtual server will perform more efficiently on a first host computing system than on a second host computing system; and
responsive to determining the virtual server will perform more efficiently on a first host computing system, listing the first host computing system before the second host computing system on a ranked list of host computing systems.

5. The method of claim 1, wherein the collected information relating to the plurality of virtual servers includes at least one of: a type of virtual server, a type and a priority of workload being processed by a virtual server, an operating system of a virtual server, a host computing system of a virtual server, and security and software information of a virtual server.

6. The method of claim 1, wherein the collected information relating to the plurality of host computing systems includes at least one of: a location of a host computing system, a hardware of a host computing system, a current configuration of virtual servers on a host computing system, a relationship between hardware and software in a host computing system, and updates to security or other software, including device software or firmware, of a host computing system.

7. A method for deploying computing infrastructure, comprising integrating computer readable code into a computing system, wherein the code in combination with the computing system is adapted to perform the method of claim 1.

8. A computer program product for recommending placement of virtual servers within a virtualized computing environment, the computer program product comprising:
one or more computer-readable tangible storage media; and
program instructions stored on the one or more computer-readable tangible storage media, the program instructions comprising:
program instructions to collect information relating to a plurality of virtual servers within a virtualized computing environment;
program instructions to collect information relating to a plurality of host computing systems within the virtualized computing environment, wherein one or more of the plurality of host computing systems hosts at least one of the plurality of virtual servers;
program instructions to measure efficiency of at least one of the plurality of virtual servers located on a current host computing system within the virtualized computing environment;
program instructions to determine, by one or more computer processors, based on the collected information relating to the plurality of virtual servers and the collected information relating to the plurality of host computing systems, whether the efficiency of the at least one virtual server will be improved with the at least one virtual server located on a second host computing system; and
responsive to determining the efficiency of the at least one virtual server will be improved with the at least one virtual server located on a second host computing system, program instructions to recommend placement of the at least one virtual server on the second host computing system.

9. The computer program product of claim 8, wherein the efficiency of the one of the plurality of the virtual servers is measured based on at least one of the following: time to complete a workload, resources required to complete a workload, success rate of a workload, errors reported during processing of a workload and ability to perform processing of multiple workloads.

10. The computer program product of claim 8, wherein the program instructions to recommend placement of the one virtual server include program instructions to send the recommendation to a virtual server placement engine.

11. The computer program product of claim 8, further comprising:
program instructions to determine, based on the collected information relating to the plurality of virtual servers and the collected information relating to the plurality of host computing systems, whether a virtual server will perform more efficiently on a first host computing system than on a second host computing system; and
responsive to determining the virtual server will perform more efficiently on a first host computing system, program instructions to list the first host computing system before the second host computing system on a ranked list of host computing systems.

12. The computer program product of claim 8, wherein the collected information relating to the plurality of virtual servers includes at least one of: a type of virtual server, a type and a priority of workload being processed by a virtual server, an operating system of a virtual server, a host computing system of a virtual server, and security and software information of a virtual server.

13. The computer program product of claim 8, wherein the collected information relating to the plurality of host computing systems includes at least one of: a location of a host computing system, a hardware of a host computing system, a current configuration of virtual servers on a host computing system, a relationship between hardware and software in a host computing system, and updates to security or other software, including device software or firmware, of a host computing system.

14. A computer system for recommending placement of virtual servers within a virtualized computing environment, the computer system comprising:
one or more computer processors;
one or more computer-readable tangible storage media; and
program instructions stored on the one or more computer-readable tangible storage media for execution by at least one of the one or more computer processors, the program instructions comprising:
program instructions to collect information relating to a plurality of virtual servers within a virtualized computing environment;
program instructions to collect information relating to a plurality of host computing systems within the virtualized computing environment, wherein one or more of the plurality of host computing systems hosts at least one of the plurality of virtual servers;
program instructions to measure efficiency of at least one of the plurality of virtual servers located on a current host computing system within the virtualized computing environment;
program instructions to determine, by one or more computer processors, based on the collected information relating to the plurality of virtual servers and the collected information relating to the plurality of host computing systems, whether the efficiency of the at least one virtual server will be improved with the at least one virtual server located on a second host computing system; and
responsive to determining the efficiency of the at least one virtual server will be improved with the at least one virtual server located on a second host computing system, program instructions to recommend placement of the at least one virtual server on the second host computing system.

15. The computer system of claim 14, wherein the efficiency of the one of the plurality of the virtual servers is measured based on at least one of the following: time to complete a workload, resources required to complete a workload, success rate of a workload, errors reported during processing of a workload and ability to perform processing of multiple workloads.

16. The computer system of claim 14, wherein the program instructions to recommend placement of the one virtual server include program instructions to send the recommendation to a virtual server placement engine.

17. The computer system of claim 14, further comprising:
program instructions to determine, based on the collected information relating to the plurality of virtual servers and the collected information relating to the plurality of host computing systems, whether a virtual server will perform more efficiently on a first host computing system than on a second host computing system; and
responsive to determining the virtual server will perform more efficiently on a first host computing system, program instructions to list the first host computing system before the second host computing system on a ranked list of host computing systems.

18. The computer system of claim 14, wherein the collected information relating to the plurality of virtual servers includes at least one of: a type of virtual server, a type and a priority of workload being processed by a virtual server, an operating system of a virtual server, a host computing system of a virtual server, and security and software information of a virtual server.

19. The computer system of claim 14, wherein the collected information relating to the plurality of host computing systems includes at least one of: a location of a host computing system, a hardware of a host computing system, a current configuration of virtual servers on a host computing system, a relationship between hardware and software in a host computing system, and updates to security or other software, including device software or firmware, of a host computing system.
